(19) United States
(12) Patent Application Publication
(10) Pub. No.: US 2014/0246102 A1
(43) Pub. Date: Sep. 4, 2014

(54) FLOW CONTROL VALVE

(71) Applicants: Koki Uno, Susono-shi (JP); Hiroo Tabushi, Seto-shi (JP); Takaaki Ichikawa, Motosu-shi (JP); Kiyotaka Kasugai, Ogaki-shi (JP); Koji Nakayama, Ogaki-shi (JP)

(72) Inventors: Koki Uno, Susono-shi (JP); Hiroo Tabushi, Seto-shi (JP); Takaaki Ichikawa, Motosu-shi (JP); Kiyotaka Kasugai, Ogaki-shi (JP); Koji Nakayama, Ogaki-shi (JP)

(73) Assignees: Toyota Jidosha Kabushiki Kaisha, Toyota-shi, Aichi-ken (JP); Pacific Industrial Co., Ltd., Ogaki-shi (JP)

(21) Appl. No.: 14/349,964

(22) PCT Filed: Oct. 5, 2012
(86) PCT No.: PCT/IB2012/002185

§ 371 Date: Apr. 4, 2014

(30) Foreign Application Priority Data
Oct. 7, 2011 (JP) 2011-223187

(51) Int. Cl. G05D 7/01

(52) U.S. Cl. CPC G05D 7/012
USPC 137/504; 137/497

(57) ABSTRACT

A flow control valve includes a housing that includes a fluid inlet and a fluid outlet; a valve body that together with the housing, forms a first chamber with a variable volume and a second chamber with a variable volume; a communication passage that connects the first chamber and the second chamber together; and an urging portion that urges the valve body in a direction in which the volume of the first chamber decreases. When the valve body moves in a direction to increase the volume of the first chamber against urging force of the urging portion, the valve body moves closer to the fluid outlet and reduces a degree to which the second chamber is communicated with the fluid outlet.

### BACKGROUND OF THE INVENTION

1. Field of the Invention

The invention relates to a flow control valve, and more particularly, to a pressure compensating flow control valve that controls a flowrate of fluid so that it is constant, regardless of a fluctuation in the pressure of fluid that flows into the flow control valve.

2. Description of Related Art

Pressure compensating flow control valves of various structures have been proposed. Japanese Utility Model Application Publication No. 5-54875 (JP 5-54875 U) describes a flow control valve that controls a flowrate of fluid so that it is constant, even when the pressure of the fluid fluctuates, by arranging an O-ring between a case and a core, and having the fluid press against the O-ring via the core, such that the O-ring elastically deforms thereby reducing the passage sectional area of the flow path, when the pressure of the fluid increases.

In the flow control valve described in the related art, the passage sectional area of the flow path is reduced by elastic deformation of the O-ring that is made of rubber or the like. Because the elastic deformation characteristic of the O-ring is affected by the fluid temperature and the type of fluid, the fluid temperature range and the type of fluid are limited. Also, the flow control performance of the flow control valve tends to be adversely effected by aging deterioration of the O-ring, making it difficult to ensure high reliability over an extended period of time. Moreover, because the passage sectional area of the flow path is increased and decreased by elastic deformation of the O-ring in the radial direction, it is difficult to reduce the diameter of the flow control valve.

Also a pressure compensating flow control valve is a spool valve-type flow control valve that has a spool valve and an urging portion that urges a spool valve in a direction that reduces the passage sectional area. However, with the spool valve-type flow control valve, it is necessary to introduce pressure of the fluid on the upstream side and the downstream side to both sides of the spool valve in the direction in which the spool valve moves. Therefore, the structure becomes complex, and the dimension of the spool valve in the direction in which the spool valve moves increases.

### SUMMARY OF THE INVENTION

The invention thus provides a pressure compensating flow control valve that tends not to be affected by fluid temperature range or fluid type, and operates stably over an extended period of time.

A first aspect of the invention relates to a flow control valve that has a housing that includes a fluid inlet and a fluid outlet; a valve body that is reciprocatably arranged inside the housing, and that, together with the housing, forms a first chamber with a variable volume that is communicated with the fluid inlet and a second chamber with a variable volume that is communicated with the fluid outlet; a communication passage that communicatively connects the first chamber and the second chamber together; and an urging portion that urges the valve body in a direction in which the volume of the first chamber decreases. When the valve body moves in a direction that increases the volume of the first chamber against urging force of the urging portion, the valve body moves closer to the fluid outlet and reduces a degree to which the second chamber is communicated with the fluid outlet.

According to this aspect, fluid flows into the first chamber through the fluid inlet, moves from the first chamber into the second chamber through the communication passage, and then flows out of the flow control valve through the fluid outlet. Differential pressure is created between the first chamber and the second. chamber as a result of the pressure dropping hen the fluid moves from the first chamber into the second chamber through the communication passage. This differential pressure causes the valve body to move against the urging force of the urging portion, in a direction that increases the volume of the first chamber. When the valve body moves in this way, the valve body comes closer to the fluid outlet, thereby reducing the degree to which the second chamber is communicated with the fluid outlet. The amount that the valve body moves increases as the pressure of the fluid flowing into the first chamber from the fluid inlet increases and the differential pressure between the first and second chambers increases. Therefore, the amount of decrease in the degree of communication between the second chamber and the fluid outlet also increases as the pressure of the fluid that flows in increases. Accordingly, the throttling effect on the fluid that flows-out of the flow control valve through the fluid outlet becomes greater as the pressure of the fluid that flows in increases. Therefore, even if the pressure of fluid that flows in fluctuates, unless that fluctuation is sudden, the flowrate of the fluid that passes through the flow control valve is able to be kept constant.

Also, the degree to which the second chamber is communicated with the fluid outlet is determined by the gap between the valve body and the fluid outlet. The valve body and the housing may be essentially rigid bodies that tend not to be affected by the fluid temperature or type, and tend not to be susceptible to the adverse effects of aging deterioration, compared with an O-ring or the like. Therefore, compared with the flow control valve of the related art described above in which the throttling of the fluid passing through the flow control valve is determined by the amount of elastic deformation of the O-ring, the flow control valve tends not to be affected by the fluid temperature or type of fluid, and is able to operate stably over an extended period of time.

Also, in the aspect described above, reducing the degree to which the second chamber is communicated with the fluid outlet may be the valve body reducing an effective passage sectional area between the second chamber and the fluid outlet. Also, in the structure described above, when fluid is not flowing through the flow control valve, the valve body may be positioned in a reference position abutting against an abutting portion of the housing, and an effective passage sectional area of the communication passage may be equal to or less than an effective passage sectional area between the second chamber and the fluid outlet when the valve body is positioned in the reference position.

According to this structure, the communication passage is able to display a higher throttling effect on the fluid from the very beginning when the fluid starts to flow into the flow control valve than it is between the second chamber and the fluid outlet. As a result, differential pressure is able to be created between the first and second chambers from the very beginning when the fluid starts to flow. Accordingly, the flowrate is able to be effectively controlled so that it is constant from a region where the pressure of fluid that flows into the flow control valve is low, compared with when the effective passage sectional area of the communication passage is larger than the effective passage sectional area between the second chamber and the fluid outlet when the valve body is positioned in the reference position. It is also possible to effectively suppress the flowrate of the fluid that passes through the flow control valve from suddenly increasing even if the pressure of the fluid that flows into the flow control valve suddenly increases.

Also, in the structure described above, the valve body may include a disc portion that extends perpendicular to a reciprocating direction of the valve body, and a cylindrical portion that is integrally formed as one piece with the disc portion and reciprocatably fits in the housing. Also, the fluid outlet may be positioned inside the cylindrical portion, and a portion of the urging portion may be positioned around the fluid outlet and inside the cylindrical portion.

According to this structure, the valve body has the cylindrical portion that reciprocatably fits in the housing, the fluid outlet is positioned inside the cylindrical portion of the valve body, and a portion of the urging portion is positioned around the fluid outlet and inside the cylindrical portion. With this structure, compared with when the cylindrical portion is not provided, rattling of the valve body is reduced, so smooth reciprocating movement of the valve body with respect to the housing main body is able to be ensured. Also, for example, compared with a case in which the valve body is a disc that has a thickness that is the same as the length of the cylindrical portion, the weight of the valve body is able to be reduced, so the size of the flow control valve in the reciprocating direction of the valve body is able to be reduced. Accordingly, the flow control valve that is able to operate stably over an extended period of time is able to be made lightweight and compact.

Also, in this structure, the communication passage may not overlap with an end portion of the fluid outlet that is on a side with the second chamber, when viewed along the reciprocating direction of the valve body.

According to this structure, when the valve body abuts against the end portion of the fluid outlet that is on the side with the second chamber, communication between the second chamber and the fluid outlet is cut off. Therefore, when the pressure of the fluid that flows into the flow control valve becomes extremely high, the valve body comes close to the fluid outlet, so the flowrate of the fluid in the space between the valve body and the fluid outlet becomes extremely high, and the pressure of that space decreases. Also, the flowrate of the fluid that passes through the flow control valve decreases, so the pressures within the first and second chambers become essentially the same. Therefore, differential pressure between the pressures in the first and second chambers and the pressure at the fluid outlet, and force from the difference in the pressure receiving area of the valve body cause the valve body to abut against the fluid outlet against the urging force of the urging portion, thus enabling the fluid flowing through the flow control valve to be cut off (i.e., to be interrupted).

Even if the flow control valve cuts off the flow of fluid in this way, if the pressure of the fluid that is trying to flow into the flow control valve is decreased, the differential pressure between the pressure within the first chamber and the pressure at the fluid outlet will decrease, so the urging force of the urging portion will move the valve body in a direction that reduces the volume of the first chamber. Accordingly, when the pressure of the fluid that tries to flow into the flow control valve is decreased, the flow control valve is able to automatically return to a normal operating state that controls the flowrate so that it is constant.

Also, in the structure described above, the communication passage may at least partially overlap with an end portion of the fluid outlet that is on a side with the second chamber, when viewed along the reciprocating direction of the valve body.

According to the structure described above, even if the valve body abuts against the fluid outlet, communication between the second chamber and the fluid outlet will not be cut off. Therefore, even if the pressure of fluid that flows into the flow control valve becomes extremely high, flow of the fluid through the flow control valve can still be ensured. When the valve body abuts against the fluid outlet, the portion where the communication passage and the fluid outlet overlap acts as an orifice. Therefore, when the pressure of fluid that flows in becomes extremely high, the flowrate of the fluid that passes through the flow control valve will not be constant.

In the various structures described above, a sectional area of the valve body that is perpendicular to an axis may be greater than a sectional area of the fluid inlet. Also, in the various structures of the invention described above, the urging portion that urges the valve body may be a compression coil spring.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a longitudinal sectional view of a flow control valve according to a first example embodiment of the invention;

FIG. 2 is a longitudinal sectional view of a flow control valve according to a second example embodiment of the invention;

FIG. 3 is a graph showing a frame format of the relationship between a pressure of a first chamber and a flowrate of fluid flowing that flows through the flow control valve in the first example embodiment (denoted by the solid line) and a comparative example (denoted by the broken line); and

FIG. 4 is a graph showing a frame format of the relationship between the pressure of the first chamber and the flowrate of fluid flowing that flows through the flow control valve in the second example embodiment.

### DETAILED DESCRIPTION OF EMBODIMENTS

Several example embodiments of the invention will now be described in detail.

### First Example Embodiment

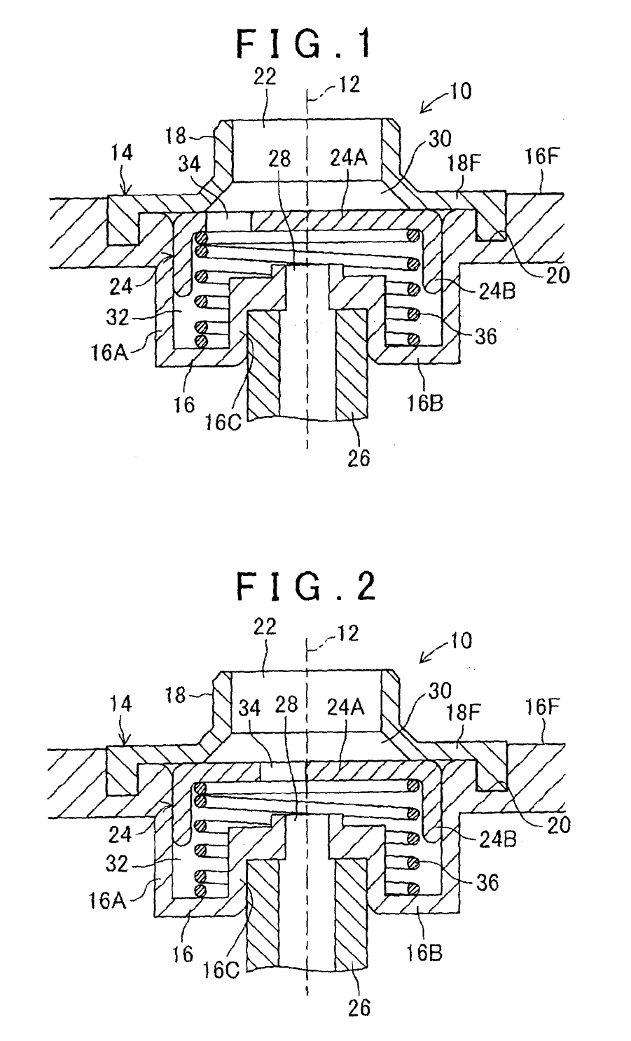

FIG. 1 is a longitudinal sectional view of a flow control valve according to a first example embodiment of the invention.

A flow control valve 10 includes a housing 14 that has an axis 12. The housing 14 is formed by a housing main body 16 and an inlet member 18. The housing main body 16 has a flange portion 16F that extends perpendicular to the axis 12, and an annular groove 20 that extends around the axis 12 is provided in an upper surface of the flange portion 16F.

The inlet member 18 has a flange portion 18F. A circular cylindrical portion that is integrally formed with a lower surface on the outer periphery of this flange portion 18F is press-fit into the annular groove 20. The inlet member 18 is connected to the housing main body 16 in an integrated manner by this press-fitting. The inlet member 18 has a circular cylindrical portion to which another conduit is connected, on the upper end in the drawing. This circular cylindrical portion forms a fluid inlet 22. Also, the inlet member 18 has a tapered portion, the diameter of which gradually increases toward the flange portion, between the circular cylindrical portion and the flange portion 18F.

A valve body 24 is reciprocatably arranged (i.e., arranged so as to be able to move back and forth) along the axis 12 inside the housing 14. The valve body 24 has a circular disc portion 24A that extends perpendicular to the axis 12, and a circular cylindrical portion 24B that is integrally formed as one piece with the outer peripheral portion of the circular disc portion 24A and extends along the axis 12. The housing main body 16 has an outer cylindrical portion 16A that extends along the axis 12 and is integrally formed as one piece with the flange portion 16F, and an inner cylindrical portion 16C that extends along the axis 12 and is integrally formed as one piece with the outer cylindrical portion 16A via a bottom wall portion 16B that extends perpendicular to the axis 12. Thus, the outer cylindrical portion 16A, the flange portion 16F, and the inner cylindrical portion 16C are formed as a single piece. A conduit 26 is connected to the inner cylindrical portion 16C by press-fitting. An upper end of the inner cylindrical portion 16C forms a fluid outlet 28.

An outer surface of the circular cylindrical portion 24B effectively closely abuts against an inner surface of the outer cylindrical portion 16A of the housing main body 36. As a result, the valve body 24, together with the housing 14, forms a first chamber 30 that is communicated with the fluid inlet 22, and a second chamber 32 that is communicated with the fluid outlet 28. The volumes of the first chamber 30 and the second chamber 32 are able to be changed, i.e., increased and decreased, by the valve body 24 moving along the axis 12. A communication passage 34 that communicatively connects the first chamber 30 with the second chamber 32 is provided in the circular disc portion 24A of the valve body 24.

In this first example embodiment, when viewed along the axis 12, the communication passage 34 is provided in a position offset in a direction perpendicular to the axis 12, so as not to overlap with the fluid outlet 28. Also, when the circular disc portion 24A of the valve body 24 abuts against the upper end of the inner cylindrical portion 16C, the upper end of the inner cylindrical portion 16C closely contacts the circular disc portion 24A of the valve body 24 around the entire periphery thereof. As a result, when the circular disc portion 24A of the valve body 24 abuts against the upper end of the inner cylindrical portion 16C, communication between the second chamber 32 and the fluid outlet 28 is cut off.

A compression coil spring 36 that serves as an urging portion that urges the valve body 24 in a direction that reduces the volume of the first chamber 30, is provided between the circular disc portion 24A of the valve body 24 and the bottom wall portion 16B of the housing main body 16, inside the second chamber 32. The circular disc portion 24A of the valve body 24 has an outer diameter that is larger than an inner diameter of the flange portion 18F of the inlet member 18. Therefore, when fluid is not flowing through the flow control valve 10, the circular disc portion 24A of the valve body 24 is positioned in a reference position in which it abuts against the flange portion 18F. Therefore, the inner peripheral portion of the lower surface in the drawing of the flange portion 18F functions as an abutting portion for positioning the valve body 24 in the reference position. An effective passage sectional area of the communication passage 34 will be designated A1, and an effective passage sectional area between the second chamber 32 and the fluid outlet 28 will be designated A2. When the valve body 24 is positioned in the reference position, the effective passage sectional area A1 and the effective passage sectional area A2 are set such that the effective passage sectional area A1 is equal to or less than the effective passage sectional area A2.

The housing main body 16, the inlet member 18, and the valve body 24 are made of essentially rigid metal or hard resin that is extremely stable and not easily affected by the temperature or type of fluid that flows through the flow control valve 10. Similarly, the compression coil spring 36 is made of elastic metal or resin that is extremely stable and not easily affected by the temperature or type of fluid that flows through the flow control valve 10.

In the first example embodiment, when fluid such as oil flows through the flow control valve 10, the fluid flows into the first chamber 30 through the fluid inlet 22, then moves into the second chamber 32 through the communication passage 34, and is discharged into the conduit 26 by the flow control valve 10 through the fluid outlet 28. Also, if the pressure drops when the fluid is passing through the communication passage 34, a pressure P2 within the second chamber 32 will consequently become lower than a pressure P1 of the first chamber 30, such that a differential pressure P1−P2 occurs on both sides of the valve body 24. Therefore, unless the change in the pressure P1 is sudden, the valve body 24 will move in the direction that reduces the volume of the second chamber 32 to a position where a force corresponding to the product of the differential pressure P1−P2 and the effective area S of the valve body 24, and a spring force of the compression coil spring 36 balance out. Therefore, the effective passage sectional area A2 between the second chamber 32 and the fluid outlet 28 is reduced, and as a result, a pressure drop also occurs between the second chamber 32 and the fluid outlet 28.

When the pressure of the fluid at the fluid outlet 28 is designated P3, a flowrate V1 of fluid passing through the communication passage 34 and a flowrate V2 of fluid passing between the second chamber 32 and the fluid outlet 28 can be expressed by Expressions 1 and 2, respectively, below. In Expressions 1 and 2, coefficients K1 and K2 are flowrate coefficients, and are values that are determined by the density of the fluid and the like.

V1=K1A1(P1−P2)^{1/2} (1)

V2=K2A2(P2−P3)^{1/2} (2)

The flowrates V1 and V2 of the fluid are equal to each other, so Expression 3 below is satisfied.

K1A1(P1−P2)^{1/2}=K2A2(P2−P3)^{1/2} (3)

Also, a spring constant of the compression coil spring 36 is designated Kb, a compression deformation amount of the compression coil spring 36 when the valve body 24 is positioned in the reference position is designated X0, and a compression deformation amount of the compression coil spring 36 when the valve body 24 is displaced from the reference position is designated X. Expression 4 below is satisfied by the balancing out of the forces acting on the valve body 24 along the axis 12.

S(P1−P2)=Kb(X+X0) (4)

Also, the effective passage sectional area A2 between the second chamber 32 and the fluid outlet 28 is the amount that the valve body 24 is displaced from the reference position, i.e., is a function of the compression deformation amount X of the compression coil spring 36, so when this function is designated F (X), Expression 5 below is satisfied.

A2=F(X) (5)

When the pressure P3 of the fluid at the fluid outlet 28 is a known constant value such as atmospheric pressure, for example, the variables P2, A2, and X are primarily determined by Expressions 3 to 5. Therefore, the flowrates V1 and V2 of the fluid, i.e., the flowrate of the fluid passing through the flow control valve 10, is determined to be constant regardless of the pressure P1 of the first chamber 30,

Thus, according to this first example embodiment, even if the pressure P1 of the fluid that flows into the first chamber 30 fluctuates, the flowrate of the fluid passing through the flow control valve 10 is able to be controlled so that it is constant, without having to control the flow control valve 10.

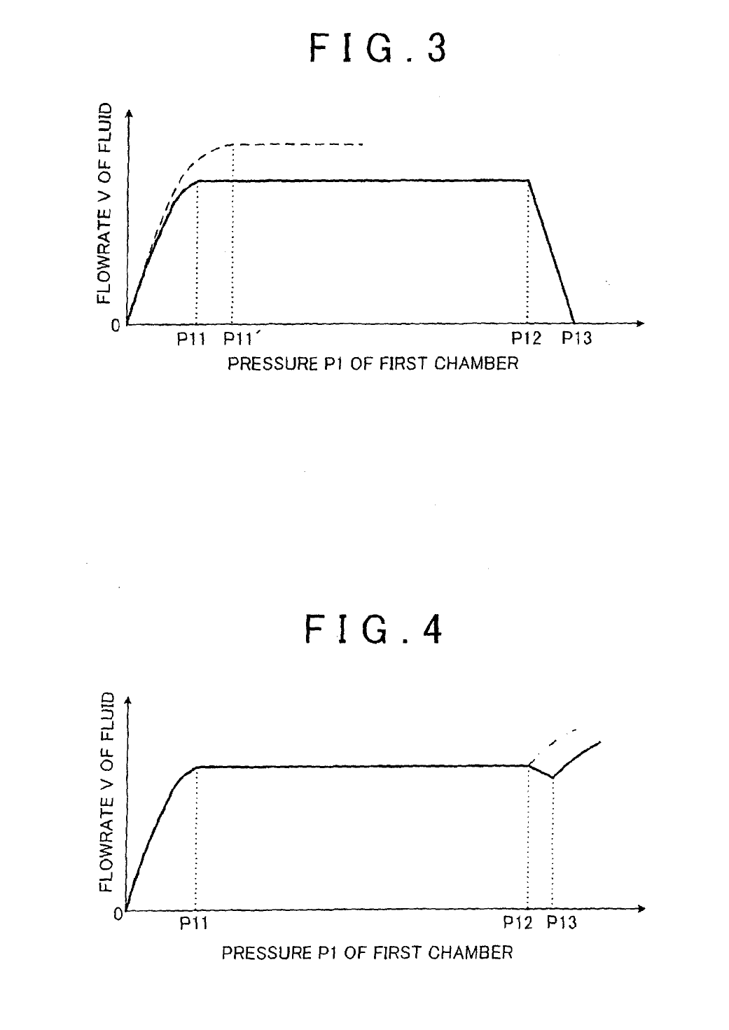

The solid line in FIG. 3 shows a frame format of the relationship between the pressure P1 of the first chamber 30 and the flowrate V of the fluid flowing through the flow control valve 10 according to the first example embodiment. When the pressure P1 increases above 0, the flowrate V of the fluid gradually increases, and when the pressure P1 reaches P11, the valve body 24 starts to be relatively displaced with respect to the housing 14 against the spring force of the compression coil spring 36. As shown in FIG. 3, when the pressure P1 becomes equal to or greater than P11, Expressions 3 to 5 are satisfied, so even if the pressure P1 of the fluid fluctuates, the flowrate V of the fluid passing through the flow control valve 10 will become constant.

Also, when the pressure P1 becomes equal to or greater than P12 that is extremely high, the effective passage sectional area A2 gradually becomes extremely low, and consequently, the flowrate V of the fluid gradually decreases. Then when the pressure P1 becomes equal to or greater than P13 that is even higher than P12, the circular disc portion 24A of the valve body 24 abuts against the upper end of the inner cylindrical portion 16C, so the flowrate V of the fluid becomes 0 as a result of communication between the second chamber 32 and the fluid outlet 28 being cut off.

Therefore, according to this first example embodiment, when the pressure of the fluid that flows into the flow control valve 10 becomes extremely high, the flowrate of the fluid that flows through the flow control valve 10 is gradually reduced and, further, fluid is able to be prevented from passing through the flow control valve 10. Accordingly, the flow control valve 10 of this first example embodiment is suitable for use when it is necessary to gradually reduce the flowrate of fluid that flows through the flow control valve to 0 when the pressure of the inflowing fluid becomes extremely high.

For example, in an oil supply system of an engine of a vehicle or the like, when the engine speed increases, the supply pressure of the oil increases, so the amount of oil supplied through a supply passage increases. Some engines simply require that at least a certain amount of oil always be supplied to the engine regardless of the engine speed. However, other engines require that only a small amount of oil be supplied through the supply passage, because as the engine speed increases, the amount of oil that is supplied by spattering and the like also increases. Therefore, the flow control valve 10 of this first example embodiment is suited to being incorporated into the latter type of engine oil supply system.

### Second Example Embodiment

FIG. 2 is a longitudinal sectional view of a flow control valve according to a second example embodiment of the invention. In FIG. 2, members that correspond to members shown in FIG. 1 will be denoted by the same reference characters used in FIG. 1.

In this second example embodiment, the communication passage 34 that is provided in the circular disc portion 24A of the valve body 24 and communicatively connects the first chamber 30 and the second chamber 32 together is provided in a position partially overlapping with the fluid outlet 28 when viewed along the axis 12. Therefore, even if the valve body 24 abuts against a tip end of the inner cylindrical portion 16C of the housing main body 16 as a result of the valve body 24 moving, fluid within the first chamber 30 is able to flow to the fluid outlet 28 through the communication passage 34. The other points of the second example embodiment are the same as they are in the first example embodiment described above.

In particular, when the circular disc portion 24A is abutted against the upper end of the inner cylindrical portion 16C of the housing main body 16 as a result of the valve body 24 moving, the effective passage sectional area of the flow path from the first chamber 30 to the fluid outlet 28 through the communication passage 34 will be designated A3. A flowrate V3 of fluid that flows from the first chamber 30 to the fluid outlet 28 through the communication passage 34 is expressed by Expression 6 below. In Expression 6, the coefficient K3 is a flowrate coefficient, and is a value that is determined by the density and the like of the fluid.

V3=K3A3(P1−P3)^{1/2} (6)

As shown in FIG. 4, in this second example embodiment, when the pressure P1 of the fluid flowing into the first chamber 30 is a value that is equal to or less than P12, the flow control valve 10 operates the same as it does in the first example embodiment. Therefore, when the pressure P1 of the fluid is within a range between P11 and P12, inclusive, the flowrate V of the fluid passing through the flow control valve 10 is maintained constant regardless of the pressure P1.

Also, when the pressure P1 of the fluid is within a range between P12 and P13, inclusive, the flowrate V of the fluid decreases slightly as the pressure P1 increases. Also, when the pressure P1 of the fluid is equal to or greater than P13, Expression 6 above is satisfied. Therefore, when the pressure P1 of the fluid is equal to or greater than P13, the flowrate V of the fluid increases as the pressure P1 increases. The amount of decrease in the flowrate V when the pressure P1 increases within a range between P12 and P13, inclusive, is larger the smaller the effective passage sectional area A3 of the flow path from the first chamber 30 to the fluid outlet 28 through the communication passage 34 is. In particular, when the effective passage sectional area A3 is a value near A1, the amount of decrease in the flowrate V is essentially 0, as shown by the alternate long and two short dashes line in FIG. 4.

Thus, according to the second example embodiment, when the pressure P1 of the fluid is within a range between P11 and P12, inclusive, the flowrate V of the fluid flowing through the flow control valve 10 is able to be maintained constant, just as it is in the first example embodiment described above.

In particular, according to the second example embodiment, even when the pressure P1 of the fluid is equal to or greater than P13, fluid is able to flow from the first chamber 30 to the fluid outlet 28 through the communication passage 34, so even if the pressure P1 of the fluid is extremely high, flow of the fluid through the flow control valve 10 is able to be ensured.

Also, according to the first and second example embodiments, the valve body 24 and the like are made of metal or resin that is extremely stable and not easily affected by the temperature or type of fluid that flows through the flow control valve 10. Therefore, compared with when the member that creates throttling action on the fluid that flows through the flow control valve 10 is made of an elastic body such as rubber, the flow control valve 10 is not easily affected by the fluid temperature range or the type of fluid, and is able to operate stably over an extended period of time.

Also, according to the first and second example embodiments, the effective passage sectional area A1 of the communication passage 34 and the effective passage sectional area A2 between the second chamber 32 and the fluid outlet 28 are set such that A1 is equal to or less than A2 when the valve body 24 is positioned in the reference position. Therefore, the communication passage 34 is able to display a higher throttling effect on the fluid than between the second chamber 32 and the fluid outlet 28, from the very beginning when the fluid starts to flow into the flow control valve 10. As a result, differential pressure between the first and second chambers is able to be created from the very beginning when the fluid starts to flow. Accordingly, the flowrate is able to be effectively controlled so that it is constant from a region where the pressure of fluid that flows into the flow control valve 10 is low, compared with when the effective passage sectional area A1 of the communication passage 34 is larger than the effective passage sectional area A2 when the valve body 24 is positioned in the reference position.

For example, the broken line in FIG. 3 shows a case of a comparative example in which the effective passage sectional area A1 is greater than the effective passage sectional area A2. In this case, the pressure of the fluid when the flowrate V of the fluid that passes through the flow control valve 10 starts to become constant is designated P11′. As shown in FIG. 3, the pressure P11 of fluid in the first and second example embodiments is able to be lower than P11′.

Also, according to the first and second example embodiments, the valve body 24 includes the circular disc portion 24A that extends perpendicular to the axis 12, and the circular cylindrical portion 24B that is integrally formed as one piece with the circular disc portion 24A and is reciprocatably fit (i.e., fit in a manner so as to be able to move back and forth) in the housing. Also, the fluid outlet 28 is positioned inside the circular cylindrical portion 24B, and a portion of the compression coil spring 36 that serves as the urging portion is positioned inside the circular cylindrical portion 24B, around the fluid outlet 28.

Therefore, compared with when the circular cylindrical portion 24B is not provided, rattling of the valve body 24 is reduced, so smooth reciprocating movement of the valve body 24 with respect to the housing main body 16 is able to be ensured. Also, for example, compared with a case in which the valve body 24 is a circular disc that has a thickness that is the same as the length of the circular cylindrical portion, the thickness and weight of the valve body are reduced, so the size of the flow control valve in the reciprocating direction of the valve body (i.e., the direction in which the valve body moves back and forth) is able to he reduced, so the flow control valve is able to be made lighter. Accordingly, the flow control valve 10 that is able to operate stably over an extended period of time is able to be made compact and lightweight.

Further, according to the first and second example embodiments, the sectional area S of the valve body 24 that is perpendicular to the axis 12 is greater than the sectional area of the fluid inlet 22, and the inlet member 18 has the tapered portion with a diameter that gradually increases toward the flange portion, between the circular cylindrical portion and the flange portion 18F. Therefore, the degree to which dynamic pressure acts on the valve body 24 when the pressure P1 of fluid that flows into the first chamber 30 suddenly fluctuates is able to be reduced compared with when the sectional area S of the valve body 24 that is perpendicular to the axis 12 is equal to or less than the sectional area of the fluid inlet 22.

Also according to the first and second example embodiments, when fluid is not flowing through the flow control valve 10, the valve body 24 abuts against the abutting portion of the flange portion 18F of the inlet member 18, and thus positioned in the reference position, due to the spring force of the compression coil spring 36. Therefore, the structure of the housing 14 is able to be simpler than it is when the abutting portion is provided on the housing main body 16.

While the invention has been described with reference to example embodiments thereof, it should be understood that the invention is not limited to the example embodiments. That is, the invention may be carried out in any of a variety of other modes without departing from the scope thereof.

For example, in the example embodiments described above, the effective passage sectional area A1 of the communication passage 34 and the effective passage sectional area A2 between the second chamber 32 and the fluid outlet 28 are set such that A1 is equal to or less than A2 when the valve body 24 is positioned in the reference position. However, the effective passage sectional area A1 of the communication passage 34 may also be set to a value greater than the effective passage sectional area A2.

Also in the first and second example embodiments described above, the fluid outlet 28 is positioned inside the circular cylindrical portion 24B, and a portion of the compression coil spring 36 that serves as the urging portion is positioned inside the circular cylindrical portion 24B, around the fluid outlet 28. However, at least one of the fluid outlet 28 and the compression coil spring 36 may also not be positioned inside the circular cylindrical portion 24B.

Also in the example embodiments described above, when fluid is not flowing through the flow control valve 10, the valve body 24 is positioned in the reference position by being made to abut against the abutting portion of the flange portion 18F of the inlet member 18 by the spring force of the compression coil spring 36. However, the abutting portion may also be formed by another portion of the housing 14.

Also in the example embodiment described above, the communication passage 34 that communicatively connects the first chamber 30 to the second chamber 32 is a hole that is formed in the circular disc portion 24A of the valve body 24. However, the communication passage may also be a groove provided in an outer surface of the circular cylindrical portion 24B of the valve body 24 or an inner surface of the outer cylindrical portion 16A of the housing main body 16, for example. Also, a communication passage may be formed by clearance between the outer surface of the circular cylindrical portion 24B and the inner surface of the outer cylindrical portion 16A.

Also in the example embodiments described above, the fluid inlet 22 is formed by the circular cylindrical portion of the inlet member 18, and the fluid outlet 28 is formed by the upper end of the inner cylindrical portion 16C of the housing main body 16. However, at least one of the fluid inlet and the fluid outlet may also be formed by a conduit that is connected and fixed to the housing of the flow control valve 10, for example.

Also in the example embodiments described above, the valve body 24 has the circular disc portion 24A and the circular cylindrical portion 24B. However, as long as the valve body 24 is reciprocatably fit in the housing 14, it does not have to be a disc portion or a cylindrical portion having a circular shape.

1-9. (canceled)

10. A flow control valve comprising:
a housing that includes a fluid inlet and a fluid outlet;
a valve body that is reciprocatably arranged inside the housing, and that, together with the housing, forms a first chamber with a variable volume that is communicated with the fluid inlet and a second chamber with a variable volume that is communicated with the fluid outlet;
a communication passage that communicatively connects the first chamber and the second chamber together; and
an urging portion that urges the valve body in a direction in which the volume of the first chamber decreases, wherein
when the valve body moves in a direction to increase the volume of the first chamber against urging force of the urging portion, the valve body moves closer to the fluid outlet and reduces a degree to which the second chamber is communicated with the fluid outlet, and
when fluid is not flowing through the flow control valve, the valve body is positioned in a reference position abutting against an abutting portion of the housing, and an effective passage sectional area of the communication passage is equal to or less than an effective passage sectional area between the second chamber and the fluid outlet when the valve body is positioned in the reference position.

11. The flow control valve according to claim 10, wherein reducing the degree to which the second chamber is communicated with the fluid outlet is the valve body reducing an effective passage sectional area between the second chamber and the fluid outlet.

12. The flow control valve according to claim 10, wherein the valve body includes a disc portion that extends perpendicular to a reciprocating direction of the valve body, and a cylindrical portion that is integrally formed as one piece with the disc portion and reciprocatably fits in the housing; and the fluid outlet is positioned inside the cylindrical portion, and a portion of the urging portion is positioned around the fluid outlet and inside the cylindrical portion.

13. The flow control valve according to claim 10, wherein the valve body includes a circular disc portion that extends perpendicular to a reciprocating direction of the valve body, and a circular cylindrical portion that is integrally formed as one piece with the circular disc portion and reciprocatably fits in the housing; and the fluid outlet is positioned inside the circular cylindrical portion, and a portion of the urging portion is positioned around the fluid outlet and inside the circular cylindrical portion.

14. The flow control valve according to claim 10, wherein the communication passage does not overlap with an end portion of the fluid outlet that is on a side with the second chamber, when viewed along the reciprocating direction of the valve body.

15. The flow control valve according to claim 10, wherein the communication passage at least partially overlaps with an end portion of the fluid outlet that is on a side with the second chamber, when viewed along the reciprocating direction of the valve body.

16. The flow control valve according to claim 10, wherein a sectional area of the valve body that is perpendicular to an axis is greater than a sectional area of the fluid inlet that is perpendicular to an axis.

17. The flow control valve according to claim 10, wherein the urging portion that urges the valve body is a compression coil spring.
